(19) United States
(12) Patent Application Publication
(10) Pub. No.: US 2010/0306669 A1
(43) Pub. Date: Dec. 2, 2010

(54) INSTANT MESSAGING SERVICE WITH MINIMIZED USER INTERFACE

(75) Inventor: Roberto Della Pasqua, Savignano Sul Rubicone (IT)

Correspondence Address: YOUNG & THOMPSON, 209 Madison Street, Suite 500, Alexandria, VA, 22314, US

(73) Assignee: ROBERTO DELLA PASQUA S.R.L., SAVIGNANO SUL RUBICONE (IT)

(21) Appl. No.: 12/095,525

(22) PCT Filed: Nov. 24, 2006
(86) PCT No.: PCT/EP2006/068895

§ 371 Date: Aug. 20, 2010

(30) Foreign Application Priority Data
Nov. 30, 2005 (IT) MI2005A002290

(51) Int. Cl. G06F 3/048

(52) U.S. Cl. 715/752; 715/784; 715/781; 715/808

(57) ABSTRACT

A method is proposed for exchanging messages among users of computers. The method includes the steps on the computer (100) of each user of: activating a window (225), the active window having a frame (305) and a workspace (310) within the frame, receiving messages in succession from the computers of other users, and displaying a conversation element (230) including an indication of a focused one of the received messages, wherein the conversation element is displayed in correspondence of the frame of the active window.

### TECHNICAL FIELD

The present invention relates to the data processing field. More specifically, the present invention relates to messaging services.

### BACKGROUND

Messaging services (especially of the instant type) have become increasingly popular, particularly in the Internet. These services allow several users to exchange messages (for example, short text phrases) in real time. For this purpose, each user accesses a server that supplies the messaging service in the Internet through a client computer (such as a PC). The user can then send to the other users and receive from them (through the server) the desired messages; this allows the users to exchange information in a direct and immediate way.

However, the known applications for the management of the messaging services are quite intrusive. Indeed, whenever a user receives a message from another user, such event is notified through the opening of a pop-up window; the user can then look over the received message and reply to it (if desired).

A problem of such solution is that the opening of the pop-up window is annoying for the user, since it distracts her/him from the work in progress; moreover, such pop-up window takes room on the screen of the client (often hiding information being useful at the moment). The problem is further exacerbated when the user receives a series of messages from different users in short succession; indeed, in such case a different pop-up window is opened on the screen for every received message (thereby multiplying the undesired effects indicated above).

Another known solution simply envisages informing the user at the receipt of any new message. Typically, such result is obtained by displaying a small icon in a task bar (being normally present at the bottom of the screen); in order to better attract the attention of the user, the icon can blink or it may be accompanied by an acoustic signal.

In such way, it is avoided cluttering the screen with annoying pop-up windows. However, the described solution does not provide any information about the received messages. Therefore, the user must always interrupt her/his work to display the received messages.

In any case, the messaging applications known in the art are rather awkward. Particularly, the operations to be executed for sending new messages and for responding to the received messages are not direct; moreover, no effective system is available for managing conversations with multiple users.

### SUMMARY

The present invention provides a solution as set out in the independent claims. Advantageous embodiments of the invention are described in the dependent claims.

In principle, the invention proposes a minimized user interface for the messaging service.

For example, an aspect of the present invention proposes a method for exchanging messages among users of computers. The method includes a series of steps, which are carried out on the computer of each user. The method starts by activating a window (for example, by selecting it with the mouse); the active window has a frame and a workspace within the frame. Different messages are received in succession from the computers of other users. The method then provides displaying a conversation element including an indication of a focused one of the received messages; this conversation element is displayed in correspondence of the frame of the active window. For example, the desired result is achieved by means of a strip in a title bar of the active window (which strip displays the last received message, or at least a part thereof).

Another aspect of the invention proposes a computer program for performing the method.

A further aspect of the invention proposes a corresponding system.

### BRIEF DESCRIPTION OF THE DRAWINGS

The invention itself, as well as further features and the advantages thereof, will be best understood with reference to the following detailed description, given purely by way of a non-restrictive indication, to be read in conjunction with the accompanying drawings, in which:

FIG. 1 is an illustrative representation of a computer that may be used to practice the solution according to an embodiment of the invention;

FIGS. 2a-2b depict an example of user interface of the computer wherein the solution according to an embodiment of the invention may be implemented;

FIGS. 3a-3r show working examples of the solution according to different embodiments of the invention; and

FIG. 4 shows the main software components that can be used to practice the solution according to an embodiment of the invention.

### DETAILED DESCRIPTION

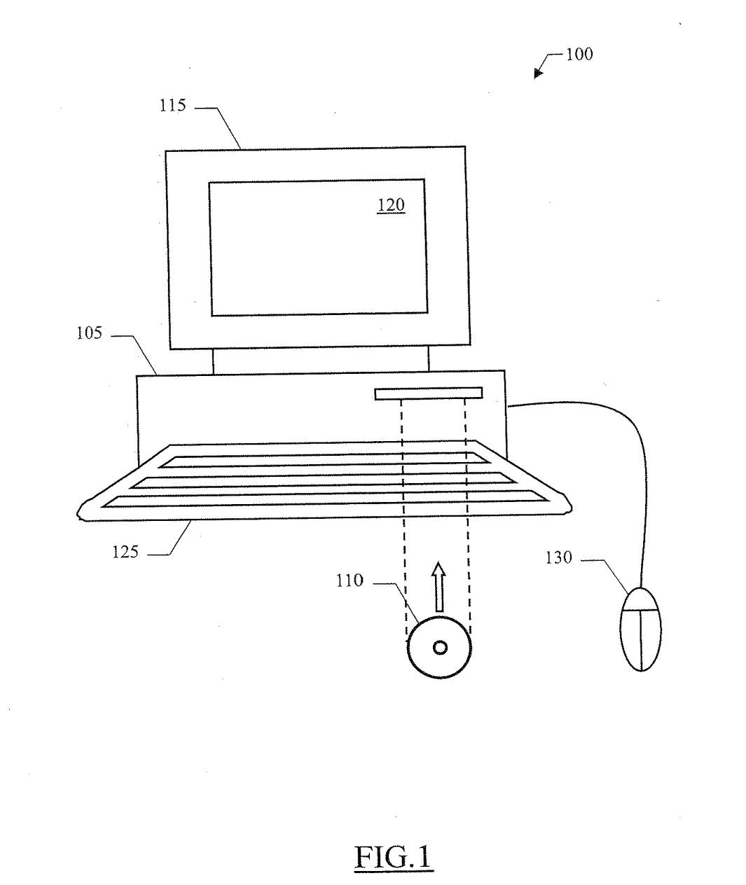

With reference in particular to FIG. 1, a computer 100 (for example, a PC) is illustrated. The computer 100 includes a central unit 105, which houses the electronic circuits controlling its operation (such as a microprocessor and a working memory). The computer 100 is also provided with a hard-disk and a drive for reading CD-ROMs 110. A monitor 115 is used to display images on a screen 120. Operation of the computer 100 is controlled by means of a keyboard 125 and a mouse 130, which are connected to the central unit 105 in a conventional manner.

The central processing unit also houses a MoDem (for example, of the ADSL type); the MoDem is used to access the Internet (through a suitable access provider). In such a way the computer 100 operates as a client, which can exploits shared resources supported by several servers of the Internet; particularly, a user of the computer 100 can connect to an instant messaging service provided by a specific server (or more). The messaging service allows the user to manage real-time conversations with other users; in particular, it is possible to send to the other users and to receive from them (through the server) instant messages, generally in the form of short text phrases.

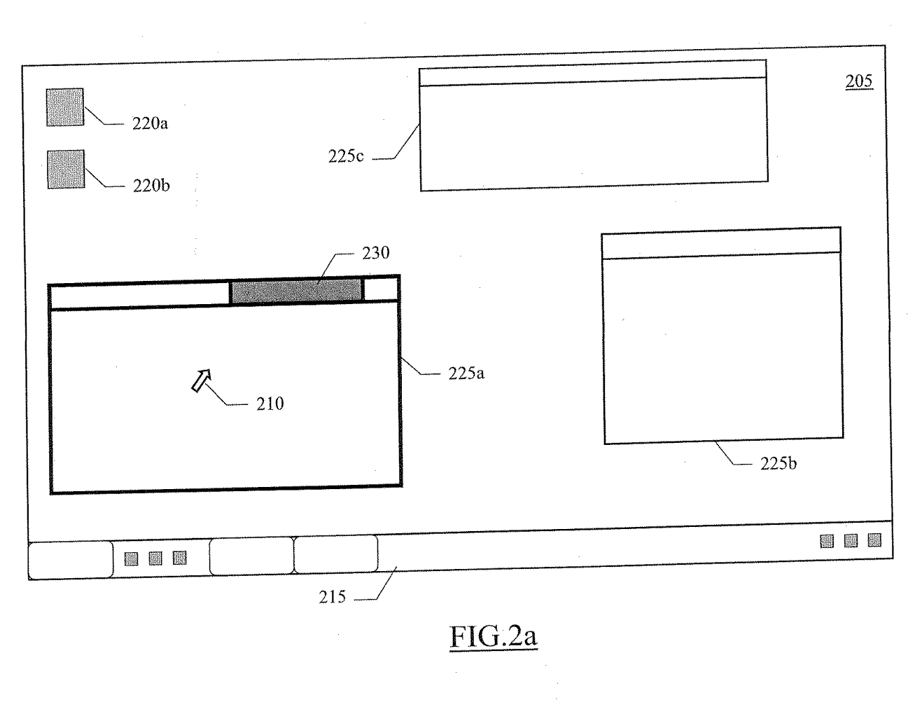

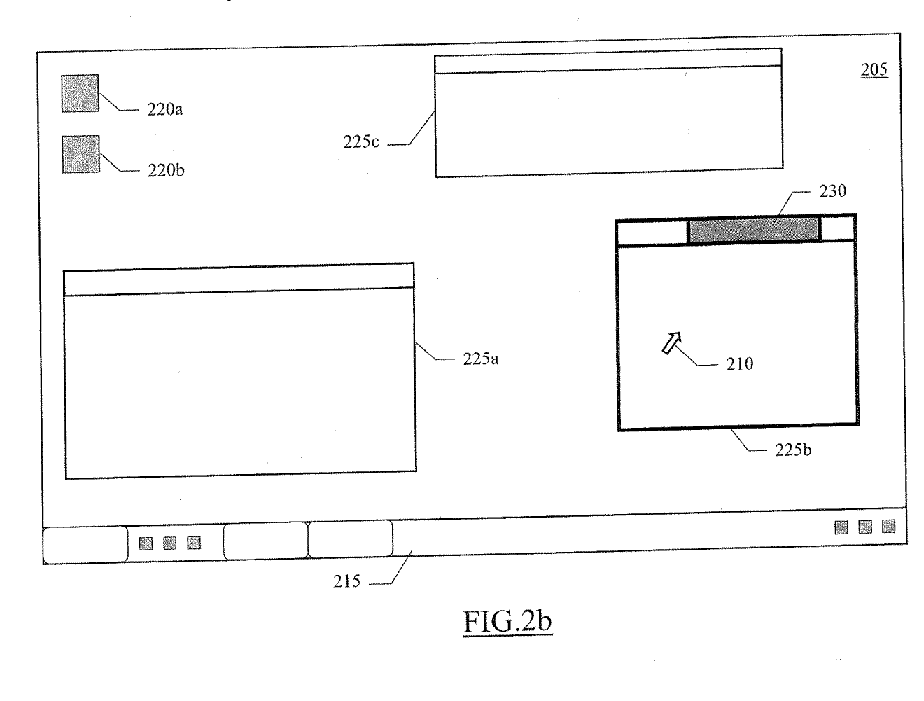

As shown in FIG. 2a, the computer is provided with a Graphical User Interface (GUI). Particularly, the screen is configured like a desktop, denoted as a whole with 205; different graphical objects are displayed on the desktop 205 for allowing the user to interact with the computer. For example, such graphical objects are used to supply information to the user; vice-versa, the user can manipulate the graphical objects and can enter commands or information (through the mouse and the keyboard); a pointer 210 (represented with an arrow) indicates a current position on the desktop 205.

In the example at issue, the desktop 205 includes a task bar 215; the task bar 215 is used to open a starting menu; moreover, it displays miniaturized icons for invoking applications of common use in a fast way or regarding minimized running applications. The remaining available part of the desktop 205 contains icons 220a, 22b for invoking applications and windows 225a, 225b, 225c for the applications currently running.

Each window 225a-225c consists of a rectangular area, which is used by the corresponding application to display information (such as images, diagrams, and texts); the window 225a-225c also includes different commands (such as menus, buttons, and the like), which are exploited by the user to interact with the application. The user can select one of the windows 225a-225c, for example, by moving the pointer 210 over it and then clicking with the mouse. Such window (for example, the window 225a) thus becomes active, and it can be used by the user. Generally, the active window 225a is emphasized (for example, by representing it in more shining tone), so as to highlight the focal point on the desktop 205.

In the solution according to an embodiment of the present invention, a conversation strip 230 is used to manage the messaging service; as described in detail in the following, such conversation strip 230 allows displaying the received messages and sending messages to the other users. The conversation strip 230 is displayed at the edge of the active window 225a, so as to not to interfere substantially with its operation.

Moreover, the conversation strip 230 follows the focal point on the desktop 205. For example, as show in FIG. 2b, let us assume that the user selects a different window as active (such as the window 225b). As a consequence, the window 225a (previously active) returns to a normal appearance, while the (new) active window 225b is now emphasized on the desktop 205. At the same time, the conversation strip 230 automatically moves from the window 225a to the window 225b. In this way, the conversation strip 230 always remains in the foreground and at the disposal of the user (but without any annoyance).

It should be noted that if all the windows are closed, the conversation strip 230 can remain suspended on the desktop 205 in its previous position (with the possibility for the user to move it to any other desired position). As soon as any window is opened (automatically becoming active), the conversation strip 230 relocates to the edge of the new active window. Alternatively, missing any windows on the desktop 205 it is also possible to add a small signaling icon in the taskbar 215 (with the conversation strip 230 that is reopened on the desktop 205 in response to a selection by the user).

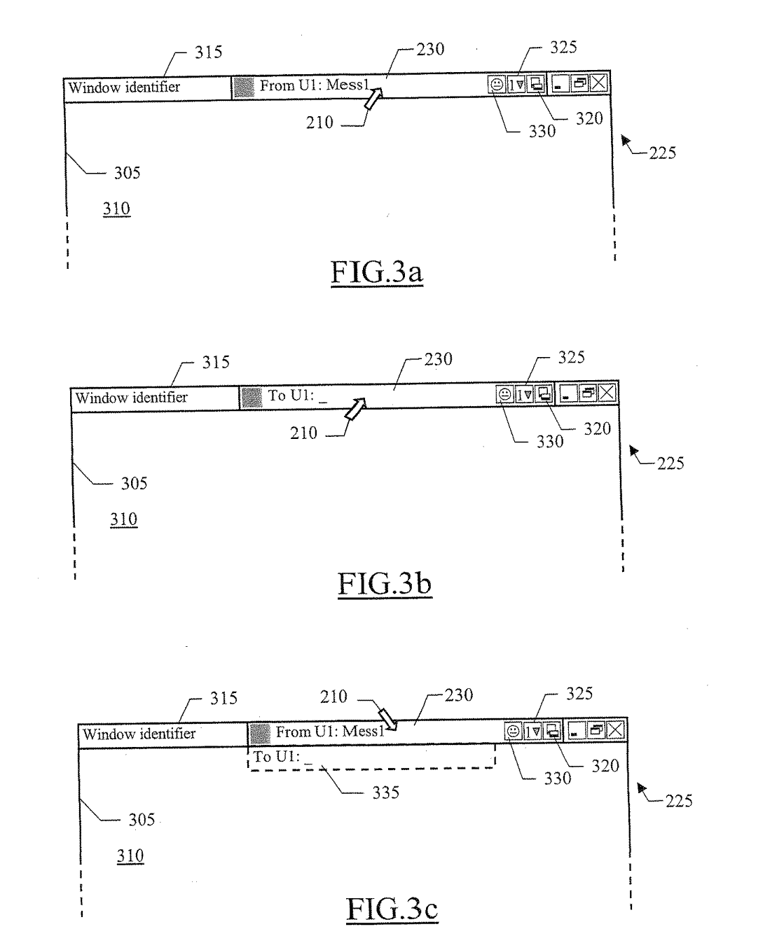

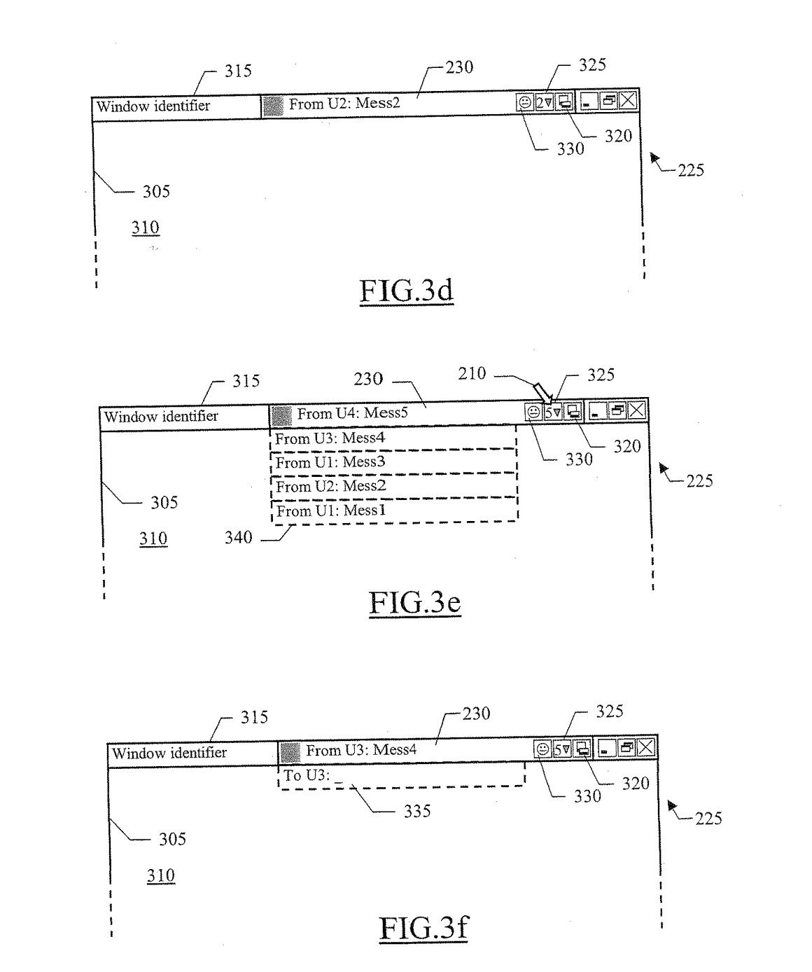

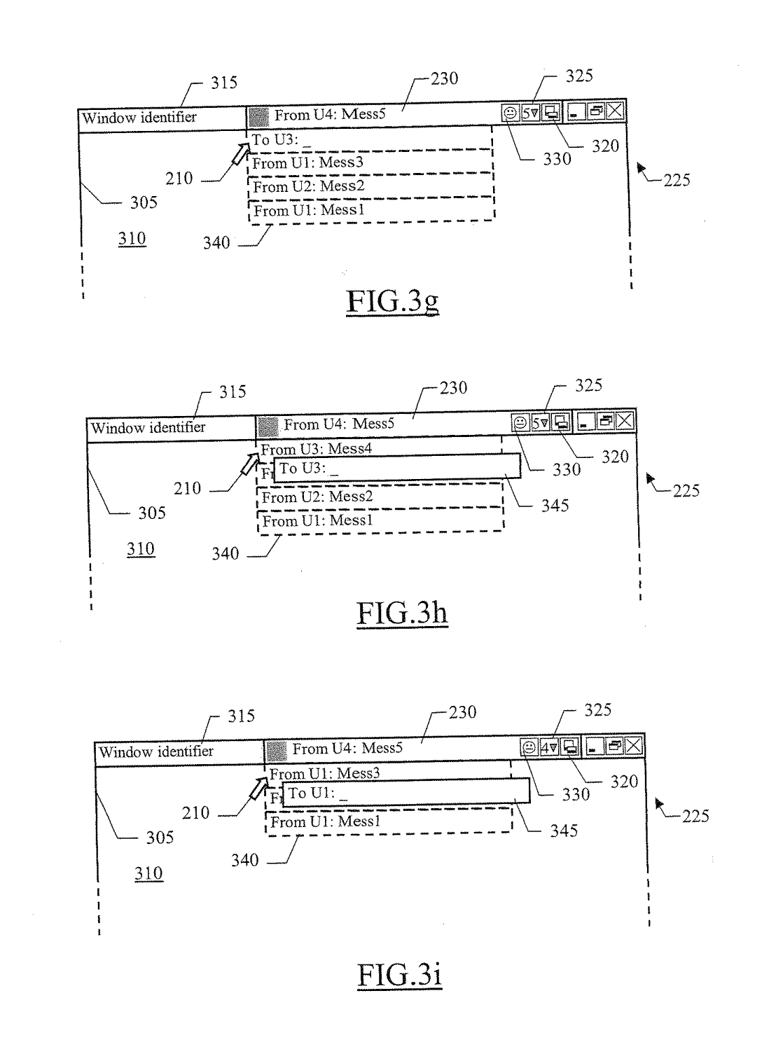

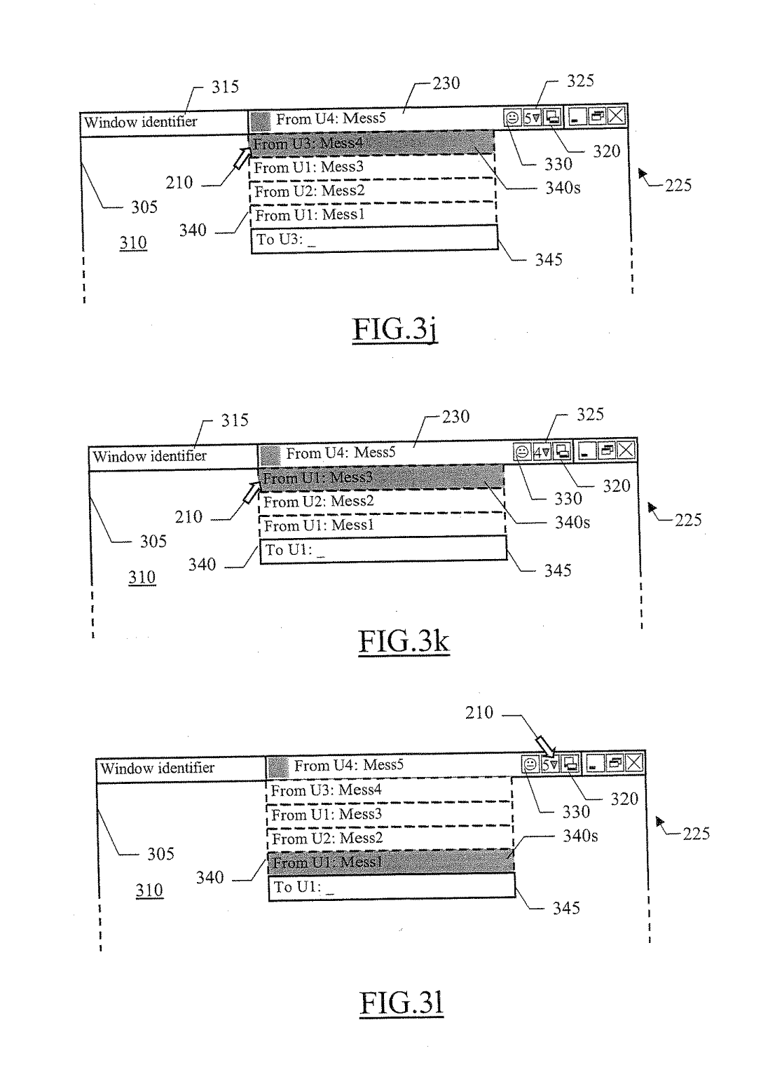

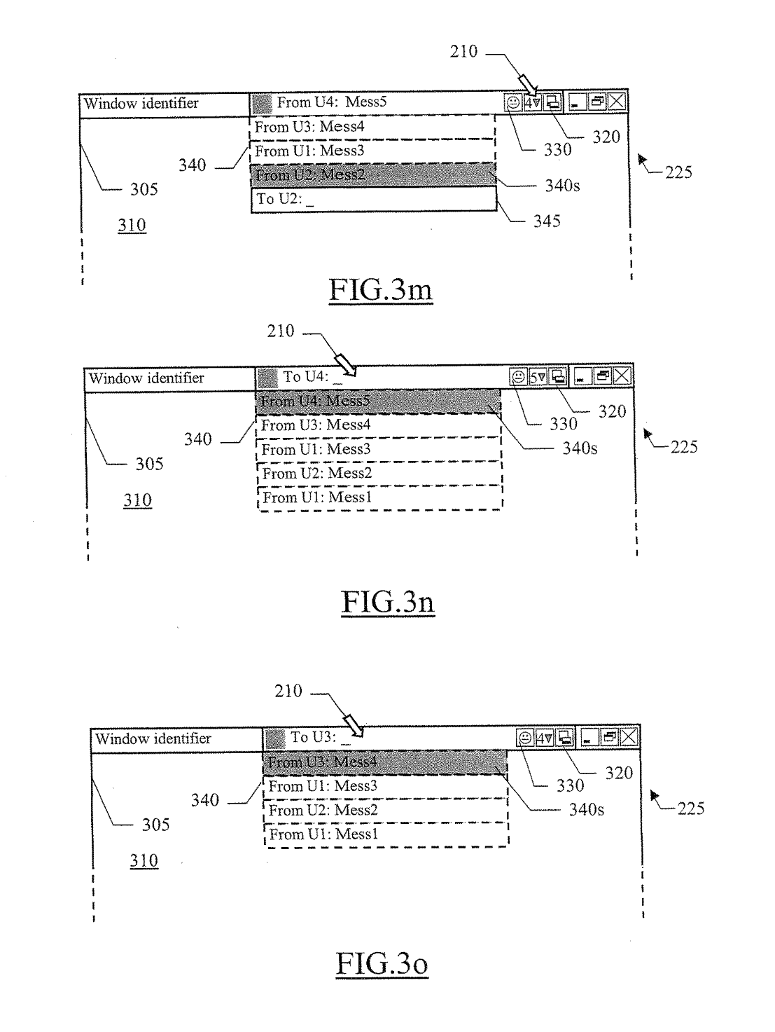

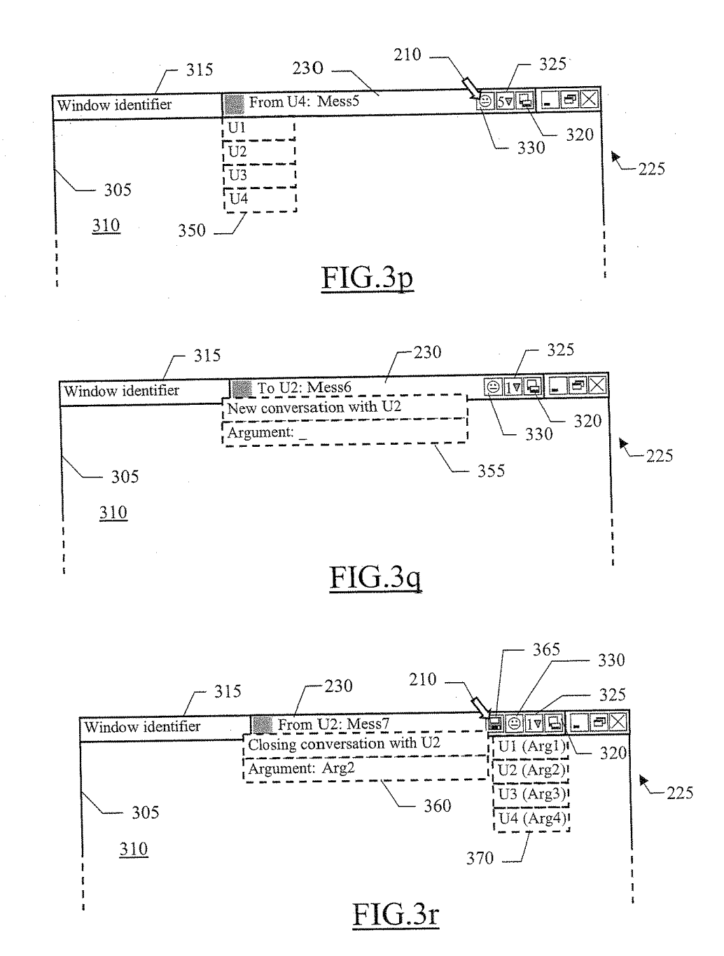

More in detail, in FIG. 3a a generic active window is denoted with 225. The window 225 includes a rectangular frame 305; a remaining part of the window 225 inside the frame 305 defines a workspace 310 (which is used to display the information and the desired commands). The upper edge of the frame 305 generally includes a title bar 315. Particularly, the title bar 315 displays an identifier being assigned to the window 225 (starting from its left end); for example, the identifier of the window consists of a graphical symbol followed by the name of the application running in the window 225. The title bar 315 also includes a series of system commands for the management of the window 225 (at its right end); for example, the system commands consist of a button for minimizing the window 225 into an icon, a button for restoring its original size, and a button for closing the window 225.

In a preferred embodiment of the invention, the conversation strip 230 is arranged in the title bar 315; in this way, it is always ready for use by the user, without interfering in any way with the operation of the window 225. Particularly, the conversation strip 230 is arranged between the identifier of the window and the corresponding system commands; as a consequence, the conversation strip 230 does not cover any useful information of the window 225.

As shown in the figure, the conversation strip 230 includes a management command 320 (for example, for configuring the messaging application and for closing the conversation strip 230); the conversation strip 230 also includes a stack command 325 (which includes a number, at the beginning equal to 0) and a list command 330, whose purposes will become evident in the following. The main part of the conversation strip 230 instead defines an output area (at the beginning empty). Such main part of the conversation strip 230 is used to display a received message; typically, the conversation strip 230 displays the name of the user followed by the text of the received message (for example, the message “Mess1” from the user “U1” in the case at issue). At the same time, the number in the stack command 325 is increased by 1 to indicate the received message.

In this way, the user can immediately look over the received message (and possibly respond to it). The result is obtained without the opening of any annoying pop-up window. Therefore, the user is not distracted during his/her work; at the same time, there is avoided any additional cluttering and there is prevented the risk of hiding information being useful at the moment.

Should the received message be too long to be contained completely in the main part of the conversation strip 230, the displayed characters are followed by a series of dots (in order to indicate its continuation). In such case, as soon as the user stops with the pointer 210 inside of the conversation strip 230 for a time exceeding a predefined threshold value (for example, 0.5-1 s), a small pop-up window with the complete received message (not shown in the figure) is opened near the conversation strip 230; such pop-up window is automatically closed as soon as the user moves the pointer 210 outside the conversation strip 230.

This maintains the sizes of the conversation strip 230 contained, but at the same time allows accessing the complete received message in every moment in a simple and fast way.

Passing now to FIG. 3b, it is possible to respond immediately to the received message. For this purpose, the user selects the main part of the conversation strip 230 (for example, by moving the pointer 210 inside it and then clicking with the mouse). In response thereto, the main part of the conversation strip 230 clears (deleting the received message), and it turns into an input area; for example, there is shown the name of the user to which it is desired to respond followed by a cursor for the entering of the desired response message. As soon as the user has typed the text of the response message (with the keyboard) and has confirmed it (pressing a sending key), the response message is automatically sent to the user at issue. At the same time, the number in the stack command 325 is decreased to 0 for indicating that no received message waiting for response exists any longer.

In this way, it is possible to respond to the received message in a simple and immediate way; the result is obtained without interfering in any way with the operation of the window 225.

An alternative solution for responding to the received message is illustrated in FIG. 3c. In this case, when the user selects the main part of the conversation strip 230 it remains unchanged. In response thereto, there is instead opened a scroll-down element 335, which is used in a similar way as an input area for typing and sending the desired response message (being then closed automatically). The scroll-down element 335 is arranged immediately below the conversation strip 230; preferably, the scroll-down element 335 is displayed in transparency on the workspace 310 of the window 225.

The proposed solution allows maintaining visible the received message (which the user is responding to); in any case, the impact on the window 255 is very limited; particularly, the display in transparency of the scroll-down element 335 allows maintaining nevertheless its content visible as a background.

With reference now to FIG. 3d, in case a new message is received (for example, the message “Mess2” from the user “U2”) before the user has responded to the previous one, the new received message replaces the previous one in the main part of the conversation strip 230 (or it simply queues up to it). At the same time, the number of the waiting messages (in the stack command 325) is increased to 2. This allows the user to look over any new received message immediately, without opening any annoying pop-up window; moreover, the user is always informed of the number of received messages which s/he must still respond to. If desired, the user can respond immediately to the new received message (focused in the conversation strip 230) according to one of the above-described modes (with the number of the waiting messages that is decremented to 1). The same operations are repeated for every new received message, again with the possibility of responding immediately to the message being focused in the conversation strip 230 (i.e., the last received message).

In any case, as shown in FIG. 3e, the user can display all the waiting messages by simply selecting the stack command 325 (for example, moving the pointer 210 over it and then clicking with the mouse). In response thereto, a scroll-down element 340 is opened 340 (in transparency on the window 225), which scroll-down element lists all the waiting messages (in reverse order of receipt moving downwards). For example, in the case at issue the scroll-down element 340 displays 5 waiting messages, as indicated by the corresponding number in the stack command 325 (i.e., the message “Mess1” from the user “U1”, the message “Mess2” from the user “U2”, the message “Mess3” from the user “U1”, the message “Mess4” from the user “U3” and the message “Mess5” from the user “U4”).

The proposed technique allows managing all the received messages within a single structure (even when the messages are received from different users).

At this point the user can select any one of the waiting messages which s/he wishes to respond to (for example, the message “Mess4” from the user “U3”). Such result is obtained by simply moving the pointer 210 over the desired waiting message and then clicking with the mouse. In response thereto, as shown in FIG. 3f, the scroll-down element 340 is closed; at the same time, the selected message replaces the last received message in the main part of the conversation strip 230 (becoming then the new focused message). In this way, it is possible to respond to the selected message exactly in the same way as described above. Preferably, as illustrated in the figure, the scroll-down element 335 is automatically opened, so as to allow the user to type and send the desired response message (maintaining the selected message visible), without requiring any further command; once the response message has been sent, the selected message is deleted and replaced in the main part of the conversation strip 230 by the last waiting message (if any); at the same time, the number of waiting messages in the stack command 325 is decremented to 4.

This allows managing conversations with more users in a very effective way.

A different solution for responding to the waiting messages is illustrated in FIG. 3g. In this case, when the user selects the desired waiting message the corresponding location of the scroll-down element 340 clears (deleting the selected message), and it turns into an input area that is used for typing and sending the desired response message. Once the response message has been sent, such location is deleted (with the possible next waiting messages that shift upwards by a position in the scroll-down element 340); at the same time, the number of the waiting messages in the stack command 325 is decremented (by 1). The same operations described above can then be repeated to respond to any other waiting message remained in the scroll-down element 340. The scroll-down element 340 is closed at the end, for example, by pressing an escape key (ESC), selecting the stack command 325 again, or after a predefined period of inactivity (such as 10-20 s).

In this way, it is possible to respond to more waiting messages in succession (without having to reopen the scroll-down element 340).

In another embodiment of the invention, as shown in FIG. 3h, an input box 345 is instead opened in response to the selection of the desired waiting message. The input box 345 consists of a small pop-up window that overlays to scroll-down element 340 near the selected message. As in the previous case, the input box 345 is used for typing and sending the desired response message. Once the response message has been sent, the input box 345 is automatically closed; at the same time, the selected message is deleted from the scroll-down element 340, and the number of the waiting messages in the stack command 325 is decremented. In this case as well, the same operations can then be repeated to respond to other waiting messages (with the scroll-down element 340 that is likewise closed at the end).

Such implementation (in addition to allowing responding to more waiting messages in succession), offers the further advantage of maintaining visible the selected message which the user is responding to.

Alternatively, as shown in FIG. 3i, once the response message has been sent, the input box 345 remains open. As a consequence, the input box 345 is now arranged near the next waiting message in the scroll-down element 340 (i.e., the message “Mess3” from the user “U1”), because of the shifting upwards caused by the deletion of the selected massage which the user has just responded to. Such message is automatically selected, with the input box 345 that is set for responding to the corresponding user. The same operations are repeated in succession for each further waiting message in the scroll-down element 340. The input box 345 and the scroll-down element 340 automatically close once responded to all the next waiting messages in the scroll-down element 340; in any case, the scroll-down element 340 and the input box 345 can always be closed upon request or for inactivity.

The proposed solution allows responding to more waiting messages in succession with the minimum number of operations.

Passing now to FIG. 3j, the same result is obtained by displaying the input box 345 near the scroll-down element 340; more precisely, the input box 345 is now arranged immediately under the first waiting message at the bottom of the scroll-down element 340 (i.e., under the oldest received message). In this case, the selected message (denoted with 340s) is preferably highlighted in the scroll-down element 340, so as to indicate to the user whose waiting message s/he is responding to (for example, with a different color, with the addition of a question point, and the like). As in the previous case, once the response message has been sent the input box 345 can be automatically closed or remain open.

In the latter case, as shown in FIG. 3k, the selected message is deleted, and the next waiting messages in the scroll-down element 340 (together with the input box 345) shift upwards by a position; at the same time, the next waiting message in the scroll-down element 340 (i.e., the message “Mess3” from the user “U1”) is automatically selected, with the input box 345 that is set for responding to the corresponding user.

A different embodiment of the invention is shown in FIG. 31. In such configuration, when the user selects the stack command 325 the first waiting message in the scroll-down element 340 (i.e., the oldest received message “Mess1” from the user “U1”) is automatically selected and highlighted (340s); the input box 345 is then opened under the selected message at the bottom of the scroll-down element 340, and it is set for responding to the corresponding user.

Passing to FIG. 3m, once the response message has been sent, the selected message is deleted and the previous waiting message in the scroll-down element 340 (i.e., the message “Mess2” from the user “U2”) is automatically selected; at the same time, the input box 345 shifts upwards by a position, and it is set for responding to the corresponding user. The same operations are repeated in succession until the user has responded to all the waiting messages in the scroll-down element 340 (which shortens accordingly until disappearing); at the end, after the user has responded to the last waiting message, the main part of the conversation strip 230 clears and the input box 345 automatically closes (being understood that the user can always close the scroll-down element 340 and the input box 345 in advance upon request or for inactivity).

In such way, it is possible to respond to all the waiting messages in succession as fast as possible.

On the contrary, as shown in FIG. 3n, when the user selects the main part of the conversation strip 230, the focused message (i.e., the last received message “Mess5” from the user “U4”) moves from the main part of the conversation strip 230 to the scroll-down element 340 (with the other waiting messages that shift downwards by a position); such message is automatically selected and highlighted (340s). The main part of the conversation strip 230 is then set for responding to the corresponding user.

With reference to FIG. 3o, once the response message has been sent, the selected message is deleted and the next waiting message in the scroll-down element 340 (i.e., the message “Mess4” from the user “U3”) is automatically selected; at the same time, the main part of the conversation strip 230 is set for responding to the corresponding user. As above, the same operations are repeated in succession until the user has responded to all the waiting messages in the scroll-down element 340 (which shortens accordingly until disappearing), always with the possibility for the user to close the scroll-down element 340 and the input box 345 in advance (upon request or for inactivity).

Considering now FIG. 3p, the user selects the list command 330 (for example, by moving the pointer 210 over it and then clicking with the mouse) when s/he wishes to send a message of his/her own motion. In response thereto, a scroll-down element 350 is opened (in transparency on the window 225), which scroll-down element 350 displays a list of the users at the moment active in the messaging service. For example, in the case at issue the scroll-down element 350 displays the users “U1”, “U2”, “U3” and “U4”. At this point the user can select anyone of the other users (by moving the pointer 210 over it and then clicking with the mouse). In response thereto, the user can type the desired message and send it to the selected user according to anyone of the above-described modes (i.e., in the main part of the conversation strip 230, in the corresponding entry of the scroll-down element 350, or in an input box either near the entry of the selected user or at the bottom of the scroll-down element 350).

Preferably, as shown in FIG. 3q, a set box 355 (for example, a small pop-up window in transparency on the window 225) is opened every time the user begins a new conversation with another user. Such event occurs when the user sends a first message to the other user in a current session of the messaging service (such as the message “Mess6” to the user “U2” in the example at issue), or when this happens after a previous conversation between them has been closed (as described in the following). In any case, the set box 355 prompts the user to enter a text that identifies the argument of the new conversation. The same set box 355 (pre-filled with the chosen argument) is also opened on the computer of the other user at the receipt of the message that begins the new conversation. The other user can then accept the chosen argument, or s/he can modify it by setting a different argument locally (which is not shared with the user who has begun the conversation).

Such argument may be used to facilitate the consultation and the search of the messages being sent and/or received (as it happens with the e-mail systems).

Moving to FIG. 3r, each conversation is automatically closed after a predefined period of inactivity (such as 5-10 minutes), during which no message has been exchanged (i.e., received and/or sent) between the two corresponding users (after the message “Mess7” from the user “U2” in the example at issue). In response thereto, a confirmation box 360 is opened (for example, a small pop-up window in transparency on the window 225); the user can then accept or modify the argument associated with the conversation to be closed. Anyway, the conversation is saved with the corresponding argument. In case a new conversation is begun later on between the same users, the respective set box is preferably pre-filled with the argument of the previous conversation; if the user accepts this argument, it is also possible to reopen the closed conversation so as to queue up the new exchanged messages thereto (without opening a new conversation).

The same operations are executed in succession for all the conversations being currently open when the session of the messaging service is finished. In addition, the user can also close one or more conversations of his/her own motion. For this purpose, the conversation strip 230 includes a save command 365. When the user selects the save command 365 (for example, by moving the pointer 210 over it and then clicking with the mouse), a scroll-down element 370 is opened (in transparency on the window 225), which scroll-down element displays a list of the conversations being open at the moment. For example, in the case at issue the scroll-down element 370 displays the conversation with the user “U1” (having for argument “Arg1”), the conversation with the user “U2” (having for argument “Arg2”), the conversation with the user “U3” (having for argument “Arg3”), and the conversation with the user “U4” (having for argument “Arg4”). At this point, the user can select anyone of the open conversations (for example, by moving the pointer 210 over it and then clicking with the mouse). In response thereto, the selected conversation is closed (with the opening of the confirmation box 360). The same operations can be repeated for the other conversations being open in the scroll-down element 370 (which shortens accordingly until disappearing), with the possibility for the user to close the scroll-down element 370 in advance (upon request or for inactivity).

The automatic closing of the conversations allows managing them in an automatic way even within the single proposed structure. The save command however ensures the maximum flexibility for their management.

Generally, the different embodiments of the invention described above can be implemented alternatively; on the contrary, different functionalities are available at the same time, and are selected by the user dynamically or during a configuration phase. For example, the conversation strip implements the solution described with reference to the FIGS. 3n-3o by default, without the save command (with the other modes of operation that can however be selected by the user at will).

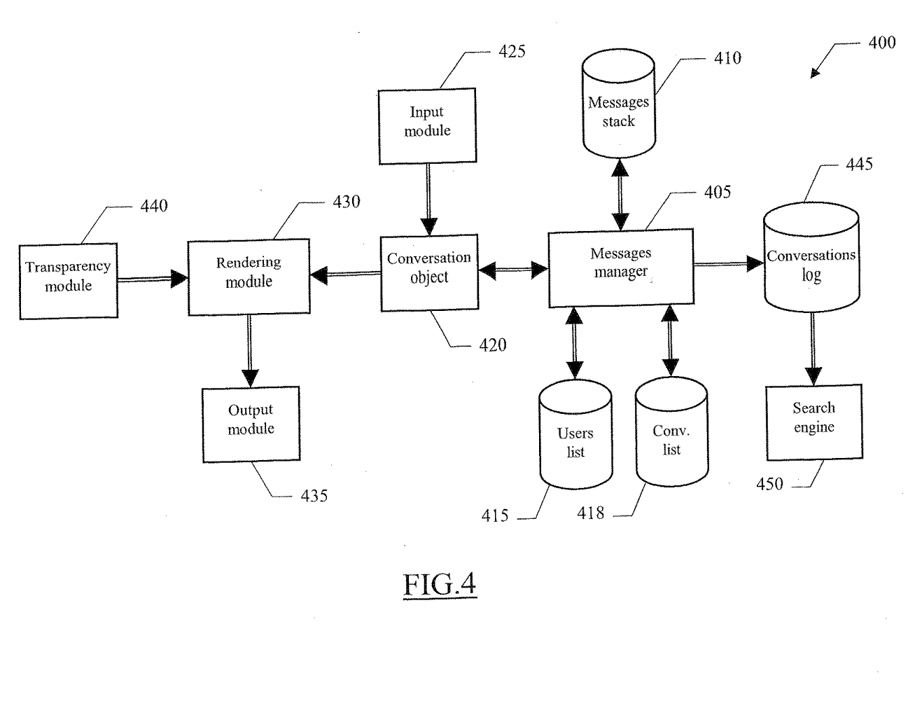

With reference now to FIG. 4, the main software components running on the above-described computer are denoted as a whole with 400. The information (programs and data) is typically stored on the hard-disk and loaded (at least partially) into the working memory of the computer when the programs are running, together with an operating system and other application programs (not shown in the figure). The programs are initially installed onto the hard disk, for example, from CD-ROM.

Particularly, a messages manager 405 implements the client side of the messaging service; for this purpose, the messages manager 405 downloads the new received messages from the server and sends the messages being entered by the user to it. The messages manager 405 saves the received messages in succession in a stack 410; at the same time, the messages manager 405 removes each received message from the stack 410 as soon as the corresponding response message has been sent. The messages manager 405 also controls a list 415 (which lists all the other users being active in the messaging service), and a list 418 (which lists all the conversations being open with the other users).

The messages manager 405 interfaces with an object 420 that implements the above-described conversation strip. More in detail, whenever a new message is received, the messages manager 405 invokes a corresponding method of this conversation object 420, which method causes its display (in the main part of the conversation strip) and the increment of the number of the waiting messages (in the stack command); moreover, the conversation object 420 passes every message being entered by the user of the computer to the messages manager 405 for its sending and the concurrent updating of the stack 410. At the same time, the messages manager 405 updates the conversations list 418 (when it is necessary). An input module 425 (of the operating system) notifies the conversation object 420 of any commands, with the possible associated information, being inserted by the user through the keyboard and/or the mouse with respect to the conversation strip (for their execution).

The conversation object 420 controls a rendering module 430, which manages the display of the conversation strip and of the other objects related thereto (i.e., the different scroll-down elements and boxes) on the monitor. For this purpose, the rendering module 430 interfaces with an output module 435 (of the operating system), which drives the monitor accordingly. Particularly, the rendering module 430 manages the display in transparency of the information on the active window by means of a multi-bit alpha channel (for example, at 8 bits). Generally, the alpha channel defines the portion of bits of each basic display element (pixel) that it reserved for transparency information; for example, in a system at 32 bits, three bytes (8×3=24 bits) are used for the red, green and blue (RGB) components, while the remaining byte specifies how to blend the RGB components when two pixels must be overlapped. This allows creating complex graphical effects, and in particular to represent objects in transparency even with non-rectangular edges (for example, rounded off).

When the operating system (such as “Microsoft Windows Vista” or “Apple OSX”) supports the multi-bit alpha channel, this result is implemented directly by the output module 435. On the contrary, other operating systems (such as “Microsoft Windows 2000”) normally manage the alpha channel at a single bit only; in this case, the obtained graphical effect is very poor, and in any case it allows representing objects with rectangular shape only in transparency. Nevertheless, it is commonly available an extension (for example, a class “WS_EX_LAYERED”), which allows implementing the multi-bit alpha channel. However, this implementation is very heavy; therefore, it is only used for representing static images, but it is completely unfeasible for the application at issue.

In this case, the rendering module 430 composes the active window through an outer window with multi-bit alpha channel, only relating to the edge of the active window (which is directly managed by the output module 435), and an opaque inner window. The inner window is generated by simulating the multi-bit alpha channel by a specific transparency module 440 (suitably optimized for this purpose). Consequently, the outer window (tied to the operating system and containing a small amount of information) is managed in a native way, while the inner window (tied to the application and containing a high amount of information) is managed in a custom way. Therefore, it is possible to obtain the desired graphical effect without substantially impairing the display speed.

At the same time, the messages manager 405 saves all the conversations with the other users in a corresponding log 445. Particularly, a new record is created at the closure of each conversation; the record includes the indication of the other user with which the conversation has occurred, the relative argument, and the sequence of all the exchanged messages (i.e., received and/or sent). A search engine 450 accesses the conversation log 450. The search engine 450 allows querying the conversation log 445 according to different criteria (for example, the arguments, the users, the dates, or the words used in the messages).

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a matter of general design choice.

For example, similar considerations apply if the computer has another structure or includes similar elements (such as cache memories temporarily storing the programs or parts thereof to reduce the accesses to the mass memory during execution); in any case, it is possible to replace the computer with any code execution entity (such as a PDA, a mobile phone, and the like).

Although in the preceding description reference has been made to a specific messaging service, this is not to be interpreted as a limitation; indeed, the same solution can also be used in similar applications, such as the direct exchange of messages (without the use of any server), a real-time conversation (or chat), and the like. Moreover, it is evident that the described messages are merely exemplificative, and that they can be replaced with any other information (for example, static or moving images, attached files, and the like).

In different embodiments of the invention, it is possible to maintain always displayed the first received message which the user must respond to, or to create different frames for the messages being received from each user.

Nothing prevents displaying the conversation strip in another position in the title bar, or more generally in correspondence of the frame of the active window (for example, beside or below), also near it (outwards when possible or inwards in transparency on the contrary). This also applies when the active window is displayed on the whole screen (for example, in videogames).

Alternatively, the conversation strip can be replaced with an equivalent element (with another appearance and/or different commands). For example, it is possible to have the conversation strip blink, with a possible acoustic signal, at the receipt of every new message (so as to attract the attention of the user); moreover, different colors for corresponding categories of messages may be used (for example, defined according to their priorities, to the users from which they are received, and the like).

It should be emphasized that the modes described above for responding to the received messages are not to be interpreted in a limitative way. Indeed, the use of a single-bit alpha channel, or even of scroll-down elements covering the workspace of the active window is not excluded. In any case, in different implementations of the invention it is possible to provide other structures, such as using the input box overlapped to the scroll-down element in proximity of the first waiting message for responding in succession to all the waiting messages (with the input box that moves progressively upwards); moreover, the input area can remain set up to send messages to the last user which it has been responded to (so as to allow performing the operation more quickly).

Alternatively, the user list can display other information (such as their mood, state, and the like); in addition, it is also possible to partition the users into groups (such as friends, colleagues, customers, managers, and the like), and then to display them in different colors according to the group they belong to.

In a different embodiment of the invention, the exchanged messages may be saved continuously while the relative conversations are in progress; moreover, the arguments can also be used like bookmarks within the several conversations (to identify any change of argument). In any case, the possibility to close the conversations upon request is not strictly necessary; in addition or in alternative, it is also possible to omit closing the conversations for inactivity (in other words, with the conversations that are saved with the respective arguments only at the closure of the session of the messaging service). Likewise, nothing prevents setting the argument only at the beginning of each conversation or only at its closure. In any case, a structure that does not support the management of the arguments is contemplated and within the scope of the invention.

Similar considerations apply if the program (which may be used to implement each embodiment of the invention) is structured in a different way, or if additional modules or functions are provided; likewise, the memory structures may be of other types, or may be replaced with equivalent entities (not necessarily consisting of physical storage media). Moreover, the proposed solution lends itself to be implemented with an equivalent method (having similar or additional steps, even in a different order). In any case, the program may take any form suitable to be used by or in connection with any data processing system, such as external or resident software, firmware, or microcode (either in object code or in source code). Moreover, it is possible to provide the program on any computer-usable medium. Examples of such medium are fixed disks (where the program can be pre-loaded), removable disks, tapes, cards, wires, fibers, wireless connections, networks, broadcast waves, and the like; for example, the medium may be of the electronic, magnetic, optical, electromagnetic, infrared, or semiconductor type.

In any case, the solution according to the present invention lends itself to be implemented with a hardware structure (for example, integrated in a chip of semiconductor material), or with a combination of software and hardware.

1. A method for exchanging messages among users of computers, the method including the steps on the computer (100) of each user of:
activating a window (225), the active window having a frame (305) and a workspace (310) within the frame,
receiving messages in succession from the computers of other users,
displaying a conversation element (230) including an indication of a focused one of the received messages,
characterized in that
the conversation element is displayed in correspondence of the frame of the active window.

2. The method according to claim 1, wherein the focused message is a last received message.

3. The method according to claim 1, wherein the messages are received from different users.

4. The method according to claim 1, wherein the frame (305) includes a title bar (315) of the active window (225), the conversation element (230) being displayed in the title bar.

5. The method according to claim 4, wherein the title bar (315) has a first end and a second end, the title bar including an identifier of the active window (225) being displayed starting from the first end and system commands for managing the active window being displayed in proximity of the second end, and wherein the conversation element (230) is displayed between the identifier of the active window and the system commands.

6. The method according to claim 1, further including the steps of:
activating a new window (225b), and
moving the conversation element (230) in correspondence of the frame of the new active window.

7. The method according to claim 1, further including the steps of:
selecting the focused message,
displaying a first input area (230;335) for the user corresponding to the focused message,
entering a first response message to the focused message in the first input area, and
sending the first response message to the computer of the user corresponding to the focused message.

8. The method according to claim 7, wherein the step of displaying the first input area (230;335) includes:
replacing the indication of the focused message in the conversation element (230) with the first input area.

9. The method according to claim 7, wherein the step of displaying the first input area (230;335) includes:
displaying a first scroll-down element (335) near the conversation element (230).

10. The method according to claim 9, wherein the first scroll-down element (335) is displayed in transparency on the workspace (310) of the active window (225).

11. The method according to claim 1, wherein a plurality of received messages are waiting for response, the waiting messages being ordered in a sequence defined by a corresponding receipt instant.

12. The method according to claim 11, further including the step of:
displaying an indication of the number of waiting messages (325) in the conversation element (230).

13. The method according to claim 11, further including the steps of:
displaying a second scroll-down element (340) in response to a predefined command, the second scroll-down element including an indication of the waiting messages ordered according to said sequence.

14. The method according to claim 13, wherein the second scroll-down element (340) is displayed in transparency on the workspace (310) of the active window (225).

15. The method according to claim 13, further including the steps of:
displaying a second input area (230;335;340;345) for the user corresponding to a selected one of the waiting messages,
entering a second response message to the selected message in the second input area, and
sending the second response message to the computer of the user corresponding to the selected message.

16. The method according to claim 15, wherein the step of displaying the second input area (230;335;340;345) includes:
replacing the indication of the focused message in the conversation element (230) with the second input area.

17. The method according to claim 15, wherein the step of displaying the second input area (230;335;340;345) includes:
replacing the focused message with the selected message in the conversation element (230), and
displaying the first scroll-down element (335) near the conversation element (230).

18. The method according to claim 15, wherein the step of displaying the second input area (230;335;340;345) includes:
replacing the indication of the selected message in the second scroll-down element (340) with the second input area.

19. The method according to claim 15, wherein the step of displaying the second input area (230;335;340;345) includes:
opening a pop-up box (345) near the second scroll-down element (340).

20. The method according to claim 19, wherein the pop-up box (345) is opened near the indication of the selected message in the second scroll-down element (340).

21. The method according to claim 19, wherein the pop-up box (345) is opened near the second scroll-down element (340), and wherein the method further includes the step of:
highlighting the indication of the selected message (340s) in the second scroll-down element (340).

22. The method according to claim 15, further including the steps of:
removing the indication of the selected message from the second scroll-down element in response to the sending of the second response message,
setting as selected a waiting message adjacent to the removed message in said sequence,
setting the second input area (230;335;340;345) for the user corresponding to the selected message,
entering a further second response message to the selected message in the second input area, and
sending the further second response message to the computer of the user corresponding to the selected message.

23. The method according to claim 15, wherein said predefined command consists of the selection of a stack command (325) in the conversation element (230), the method further including the step of:
choosing as selected one of the messages waiting in the second scroll-down element (340) in response to a selection command.

24. The method according to claim 15, wherein said predefined command consists of the selection of the focused message, the method further including the step of:
setting as selected a first one of the messages waiting in said sequence in response to the selection of the focused message.

25. The method according to claim 1, further including the steps of:
selecting a send command (330) in the conversation element (230),
displaying a third scroll-down element (350) near the conversation element, the third scroll-down element including an indication of the other users.

26. The method according to claim 25, wherein the third scroll-down element (350) is displayed in transparency on the workspace (310) of the active window (225).

27. The method according to claim 25, further including the steps of:
selecting one of the other users in the third scroll-down element (350),
displaying a third input area (230;345;350),
entering an output message for the selected user in the third input area, and
sending the output message to the computer of the selected user.

28. The method according to claim 27, wherein the step of displaying the third input area (230;345;350) includes:
replacing the indication of the focused message in the conversation element (230) with the third input area.

29. The method according to claim 27, wherein the step of displaying the third input area (230;345;350) includes:
replacing the indication of the selected user in the third scroll-down element (350) with the third input area.

30. The method according to claim 27, wherein the step of displaying the third input area (230;340;345) includes:
opening a further pop-up box (345) in proximity of the third scroll-down element (350).

31. The method according to claim 30, wherein the further pop-up box (345) is opened near the indication of the selected user in the third scroll-down element (350).

32. The method according to claim 30, wherein the further pop-up box (345) is opened near the third scroll-down element (350), and wherein the method further includes the step of:
highlighting the indication of the selected user in the third scroll-down element (350).

33. The method according to claim 1, further including the steps of:
storing (445) a conversation with each one of the other users, the conversation including a sequence of the messages exchanged with the corresponding other user, and
associating (335;360) an indication of an argument with the conversation.

34. The method according to claim 33, wherein the step of associating (335;360) the indication of the argument with the conversation is executed in response to an opening and/or a closing of the conversation.

35. The method according to claim 34, further including the step of:
closing each conversation in response to the reaching of a threshold of an inactivity period during which no message is exchanged with the corresponding other user.

36. The method according to claim 34, further including the step of:
closing each conversation in response to a save command (365).

37. The method according to claim 36, wherein the step of closing each conversation in response to the save command (365) includes:
displaying a fourth scroll-down element (370) near the conversation element (230), the fourth scroll-down element including an indication of the conversations being open with the other users,
selecting one of the open conversations in the fourth scroll-down element, and
closing the selected conversation.

38. The method according to claim 37, wherein the fourth scroll-down element (370) is displayed in transparency on the workspace (310) of the active window (225).

39. A computer program (400) for performing the method of claim 1 when the computer program is executed on a data processing system (100).

40. A system (100) including means (400) for performing the steps of the method according to claim 1.
